(19) United States
(12) Patent Application Publication
(10) Pub. No.: US 2013/0193087 A1
(43) Pub. Date: Aug. 1, 2013

(54) WATER TREATMENT DEVICE AND WATER TREATMENT METHOD

(71) Applicants: Tsuyoshi Moriya, Tokyo (JP); Kenichi Kataoka, Yamanashi (JP); Shigeru Senzaki, Miyagi (JP); Youichi Shimanuki, Yamanashi (JP); Kazuhiko Kano, Tokyo (JP)

(72) Inventors: Tsuyoshi Moriya, Tokyo (JP); Kenichi Kataoka, Yamanashi (JP); Shigeru Senzaki, Miyagi (JP); Youichi Shimanuki, Yamanashi (JP); Kazuhiko Kano, Tokyo (JP)

(73) Assignee: TOKYO ELECTRON LIMITED, Tokyo (JP)

(21) Appl. No.: 13/878,904

(22) PCT Filed: Oct. 7, 2011
(86) PCT No.: PCT/JP2011/073748

§ 371 Date: Apr. 11, 2013

(30) Foreign Application Priority Data
Oct. 14, 2010 (JP) 2010-231861

(51) Int. Cl. C02F 1/02

(52) U.S. Cl. CPC C02F 1/02
USPC 210/774; 210/175

(57) ABSTRACT

Provided is a water treatment device with which organic substances contained in raw water to be treated are decomposed to thereby alleviate the load to be imposed on a downstream filter and with which it is possible to avoid corrosion of the piping or the like.

The water treatment device 12 includes a large-bore channel 22, a small-bore channel 23, and a pressure pump 24 which pressurize raw water 15a to a given pressure, the raw water containing organic substances, and further includes a laser light source 25 and a condensing lens 26 which irradiates laser light 37 upon the pressurized raw water 15a to heat the raw water to a given temperature, wherein the laser light 27 emitted from the laser light source 25 is condensed by the condensing lens 26 on a region 29 that is located in the small-bore channel 23 through which the pressurized raw water 15a flows and that is separated from the wall of the channel, thereby heating the raw water 15a present in this region 29 and yielding supercritical water or subcritical water to decompose the organic substances contained in the raw water 15a.

### TECHNICAL FIELD

The present invention relates to a water treatment device and a water treatment method that decompose organic substances contained in raw water such as, for example, wastewater or contaminated water, using supercritical water or subcritical water.

### BACKGROUND ART

Generally, wastewater discharged from various manufacturing plants including a semiconductor manufacturing plant, a factory, or collective housing that contains various organic substances or other foreign substances is purified in a large-scale sewage treatment facility together with rain water and subjected to a fine water generation process to be recycled for tap water available for drinking water. However, for example, some remote regions away from an urban area and inland areas of developing countries may not be provided with a facility for necessary purification. In such a case, water from, for example, a river contaminated due to inflowing of wastewater or other reasons may be unavoidably used.

Further, even an urban area or an advanced country may also be placed in a situation where drinking water cannot be acquired for a certain period, for example, immediately after a disaster such as, for example, an earthquake. Therefore, there is a demand for establishing a fresh water generation technology embodied with a non-complicated facility that is capable of efficiently manufacturing tap water from, for example, factory drainage or home drainage, rainwater, or other contaminated water.

In the meantime, in a conventional sewage treatment facility, for example, tap water is produced by a fresh water generation process in such a manner that a physical treatment is used in conjunction with a biological treatment. Specifically, relatively large solids such as, for example, filth, are removed by precipitation in a large-scale water storage tank (physical treatment), then an activated sludge treatment is performed (biological treatment), and then, solids are removed by, for example, slow filtration or rapid filtration in which a coagulant is used. Subsequently, an advanced wastewater treatment such as, for example, aeration for removing color or odor or a powdered activated carbon treatment is performed, and an ozone oxidation treatment or an activated carbon adsorption treatment or the like is performed, as desired. Finally, chlorine sterilization treatment is performed.

Further, as a technique for decomposing organic waste contained in sewage water, there has been recently proposed an organic waste decomposition treatment technology which decomposes organic substances using supercritical water or subcritical water (see, e.g. Patent Document 1).

### CITATION LIST

### Patent Document

Patent Document 1: Japanese Patent Laid-Open Publication No. H11-165142

### SUMMARY OF INVENTION

### Problems to be Solved by the Invention

However, in a fresh water generation technology in which a conventional sewage water treatment facility is applied, since a substantial amount of solids such as, for example, organic substances are contained in raw water to be treated after the biological treatment, there is a problem in that the amount of raw water to be wasted without being treated occupies about 60% of the entirety of the raw water since the load imposed on the filtration device is too high to be treated. Further, in the organic substance decomposition treatment technology that decomposes organic substances by supercritical water or subcritical water, there is a problem in that since special measures to avoid corrosion of a facility such as, for example, piping, caused by contact with the supercritical water or subcritical water is needed, the configuration of the facility is complicated or the complexity in treatment process is increased.

An object of the present invention is to provide a water treatment device and a water treatment method that are capable of efficiently decomposing organic substances contained in raw water such as, for example, wastewater or contaminated water to alleviate the load to be imposed on a filtration device located downstream, and avoiding corrosion of the facility including piping or the like.

### Means to Solve the Problems

In order to solve the problems described above, in accordance with a first aspect of the present invention, there is provided a water treatment device including: a pressure device that pressurizes raw water containing organic substances to a predetermined pressure; and a heating device that heats the raw water pressurized by the pressure device at a predetermined temperature to produce supercritical water or subcritical water and decomposes the organic substances contained in the raw water using the supercritical water or subcritical water. The heating device includes a laser light irradiation device that irradiates laser light towards the raw water pressurized by the pressure device, and a condensing lens that condenses the laser light irradiated from the laser light irradiation device on a region spaced apart from a channel wall within the channel in which the pressurized raw water flows.

In the first aspect of the present invention, it is preferable that the pressure device introduces the raw water from a large-bore channel into a small-bore channel of which the cross-sectional area is smaller than that of the large-bore channel to pressurize the raw water.

In the first aspect of the present invention, it is preferable that at least a part of the channel wall of the small-bore channel is transparent, and the laser light irradiation device irradiates the laser light on a region within the small-bore channel through the transparent wall of the channel.

In the first aspect of the present invention, it is preferable that the small-bore channel has a double pipe structure, and a vacuum insulation layer is formed in a space between the inner pipe and the outer pipe of the double pipe structure.

In the first aspect of the present invention, it is preferable that the small-bore channel is has a double pipe structure, and a heat recovering gas flows in the space between the inner pipe and then outer pipe.

In the first aspect of the present invention, it is preferable that the small-bore channel has a double pipe structure, and the space between the inner pipe and the outer pipe is preferably filled with a filler having voids.

In the first aspect of the present invention, it is preferable that a thermal reflection plate is disposed on the channel wall surface inside the channel in the channel wall opposed to the channel wall of the small-diameter channel on which the laser light is irradiated.

In the first aspect of the present invention, it is preferable that the predetermined pressure is 1.5 MPa to 100 MPa, and the predetermined temperature is 200° C. to 500° C.

In the first aspect of the present invention, it is preferable that the predetermined pressure is 1.5 MPa to 100 MPa, the predetermined temperature is 200° C. to 374° C., and the raw water is in the liquid state.

In the first aspect of the present invention, it is preferable the predetermined pressure is 22 MPa to 100 MPa, and the predetermined temperature is 374° C. to 500° C.

In order to solve the problems described above, in accordance with a second aspect of the present invention, there is provided a water treatment method including: pressurizing raw water containing organic substances to a predetermined pressure; and heating the raw water pressurized by the pressurizing to a predetermined temperature to produce supercritical water or subcritical water and decomposes the organic substances contained in the raw water using the supercritical water or subcritical water. The heating includes irradiating the laser light towards the raw water pressurized by the pressurizing; and condensing the laser light irradiated in the irradiating on a region spaced apart from a channel wall within the channel where the pressurized raw water flows.

In the second aspect of the present invention, the pressurizing introduces the raw water from a large-bore channel into a small-bore channel of which the cross-sectional area is smaller than that of the large-bore channel to pressurize the raw water.

In the second aspect of the present invention, it is preferable that at least a part of the channel wall of the small-bore channel is transparent, and in the irradiating, the laser light is irradiated to a region within the small-bore channel through the transparent channel wall of the channel.

In the second aspect of the present invention, it is preferable that the small-bore channel has a double pipe structure, and the water treatment method further includes causing a gas to flow in a space between the inner pipe and the outer pipe of the double pipe structure to recover the heat discharged from the inner pipe.

In the second aspect of the present invention, it is preferable that the predetermined pressure is 1.5 MPa to 100 MPa, the predetermined temperature is 200° C. to 500° C.

In the second aspect of the present invention, it is preferable that the predetermined pressure is 1.5 MPa to 100 MPa, and the predetermined temperature is 200° C. to 374° C. and the raw water is in the liquid state.

In the second aspect of the present invention, it is preferable that the predetermined pressure is 22 MPa to 100 MPa, and the predetermined temperature is 374° C. to 500° C.

### Effect of the Invention

According to the present invention, it is possible to decompose more efficiently organic substances contained the raw water containing organic substances such as wastewater or contaminated water to reduce load to be imposed on a filtration device located at downstream, and further, prevent corrosion of facility including piping or the like.

### BRIEF DESCRIPTION OF DRAWINGS

FIG. 1 is a block diagram illustrating an example of a fresh water generation system.

FIG. 2A is a view illustrating a configuration of a main part of the water treatment device according to a first exemplary embodiment of the present invention.

FIG. 2B is a cross-sectional view illustrating a configuration of main parts of the water treatment device according to the first exemplary embodiment of the present invention taken along line B-B of FIG. 2A.

FIG. 3 is a flow chart illustrating a water treatment method according to a second exemplary embodiment of the present invention.

FIG. 4 is a view illustrating a condition of producing supercritical water and subcritical water.

FIG. 5 is a cross-sectional view of a raw water channel, which is a main part of a first modified example of the water treatment device according to the second exemplary embodiment of the present invention.

FIG. 6A is a cross-sectional view of the raw water channel at the time when the raw water is introduced in the raw water channel which is a main part of a second modified example of the water treatment device according to the first exemplary embodiment of the present invention.

FIG. 6B is a cross-sectional view of the raw water channel at the time when the raw water is pressurized in the raw water channel which is the main part of the second modified example of the water treatment device according to the first exemplary embodiment of the present invention.

FIG. 6C is a cross-sectional view of the raw water channel at the time when the raw water is heated (laser light is irradiated) in the raw water channel which is the main part of the second modified example of the water treatment device according to the first exemplary embodiment of the present invention.

FIG. 6D is a cross-sectional view of the raw water channel at the time when the raw water is discharged in the raw water channel which is the main part of the second modified example of the water treatment method according to the first exemplary embodiment of the present invention.

### DETAILED DESCRIPTION

Hereinafter, exemplary embodiments of the present invention will be described with reference to the accompanying drawings.

A water treatment device of the present invention includes: a pressure device that pressurizes raw water containing organic substances to a predetermined pressure and a heating device that heats the raw water pressurized by the pressure device to a predetermined temperature to produce supercritical water or subcritical water and decomposes the organic substances contained in the raw water using the supercritical water or subcritical water. The water treatment device constitutes a part of a fresh water generation system in which tap water is manufactured from sewage, factory drainage, living drainage, rain water, or the like, or alternatively, wastewater in the above-described sewage, the drainages and the rain water are mixed, or contaminated water from such as, for example, a river contaminated by mixed-inflow of the above-mentioned waters or other reasons.

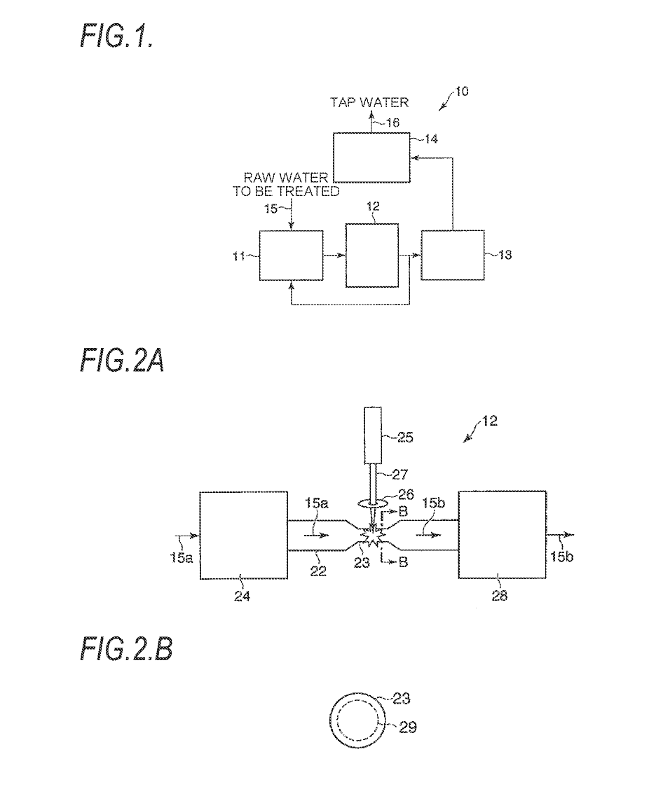

FIG. 1 is a block diagram illustrating an example of the fresh water generation system.

In FIG. 1, a fresh water generation system 10 is mainly constituted by a sewage diffusion tank 11 that decomposes or separates large solids in raw water 15 so as to adjust the raw water to equalize the load to be imposed, a water treatment device 12 that produces supercritical water or subcritical water by heating and pressurizing liquid discharged from an outlet of sewage diffusion tank 11 and decomposes organic substances in the raw water using the supercritical water or subcritical water, a reverse osmosis membrane device 13 that filters and fractionates the decomposed remnants contained in the liquid discharged from the outlet of water treatment device 12 and decomposed by water treatment device 12, and a drinking water treatment device 14 that performs a plasma processing on the liquid discharged from the outlet of reverse osmosis membrane device 13 to yield tap water 16. The decomposed remnants may include substances decomposed to a molecular level and coagulated in a cluster shape or molecules having a large size, in addition to the substances decomposed by water treatment device 12 in a fine solid state.

FIG. 2A is a view illustrating a configuration of a main part of the water treatment device according to a first exemplary embodiment of the present invention. FIG. 2B is a cross-sectional view illustrating a configuration of main parts of the water treatment device according to the first exemplary embodiment of the present invention taken along line B-B of FIG. 2A.

In FIG. 2A, water treatment device 12 includes a pressure pump 24 that introduces raw water 15a containing organic substances to be treated (hereinafter, simply referred to as “raw water”) from a large-bore channel 22 to a small-bore channel 23 to pressurize raw water 15a. Small-bore channel 23 is made of, for example, a quartz glass that is transparent and superior in heat resistance.

Raw water 15a introduced from large-bore channel 22 to small-bore channel 23 is pressurized to, for example, 25 MPa to 40 MPa, by pressure pump 24. A laser light source 25 as a laser light irradiation device is disposed on a location spaced apart from small-bore channel 23 through which pressurized raw water 15a flows. Laser light source 25 irradiates a laser light 27 towards raw water 15a that flows through small-bore channel 23. A condensing lens 26 is disposed between laser light source 25 and small-bore channel 23. Condensing lens 26 condenses laser light 27 emitted from laser light source 25 to irradiate laser light 27 to a region 29 (see, FIG. 2B) in small-bore channel 23 spaced apart from the channel wall of small-bore channel 23.

Pressurized and laser light-irradiated raw water 15a becomes a high-temperature and high-pressure raw water of, for example, 300° C. to 400° C. and 25 MPa to 40 MPa, and supercritical water or subcritical water is produced from the water components in raw water 15a. By doing this, raw water 15a turned into the supercritical water or subcritical water decomposes the organic substances contained in raw water 15a. A depressurization device 28 is provided downstream from small-bore channel 23, and, after being treated to decompose organic substances, raw water 15b flows from small-bore channel 23 into depressurization device 28 where the pressure of treated raw water 15b is recovered.

Hereinafter, descriptions will be made as to a water treatment method according to a second exemplary embodiment of the present invention performed by using the water treatment device having the configuration as described above. The water treatment is performed as a pre-treatment of a filtration process by reverse osmosis membrane device 13 in a fresh water generation system (FIG. 1), and may be executed by a CPU in a control unit according to a water treatment program stored in a memory of the control unit of fresh water generation system 10 not illustrated in the drawing.

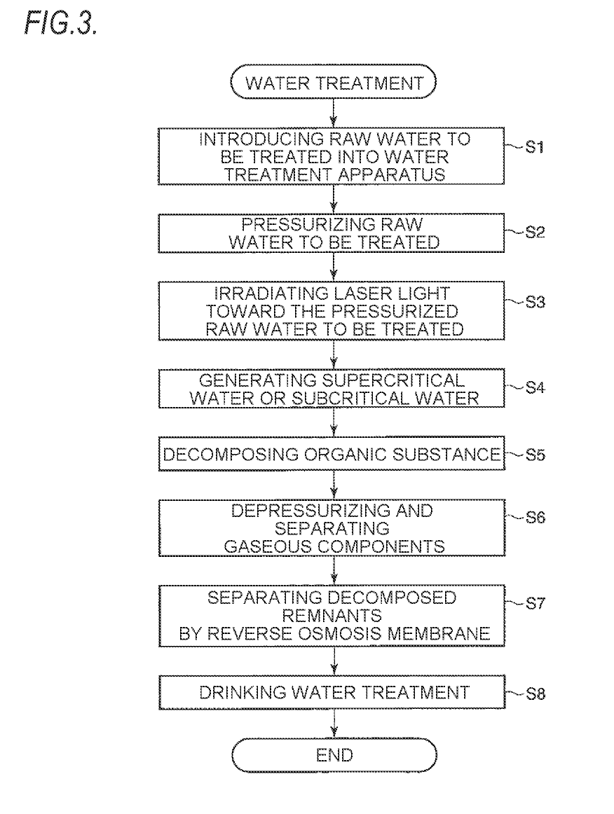

FIG. 3 is a flow chart illustrating a water treatment method according to the second exemplary embodiment of the present invention.

In FIG. 3, when treating the raw water, raw water 15a diffused in sewage diffusion tank 11 (see FIG. 1) and adjusted to equalize the load to be imposed is introduced into water treatment device 12 (FIG. 2) first (step S1), and then into small-bore channel 23 through large-bore channel 22 using pressure pump 24, thereby pressurizing raw water 15a to a predetermined pressure, for example, 25 MPa to 40 MPa (step S2).

Subsequently, laser light 27 is irradiated from laser light source 25 toward the pressurized raw water 15a that flows through small-bore channel 23 (step S3), and laser light 27 is condensed by condensing lens 26 and irradiated to region 29 in small-bore channel 23 spaced apart from the channel wall of small-bore channel 23 to heat the raw water to a temperature of 300° C. to 400° C., thereby producing supercritical water or subcritical water from the water components in raw water 15a (step S4), and the organic substances contained in raw water 15a are decomposed using raw water 15a that has been turned into the supercritical water or subcritical water (step S5).

In this case, the supercritical water decomposes the organic substances into CO₂ and the subcritical water decomposes organic substances into CH₄ gas and an infinitesimal amount of amino acid.

After being treated to decompose the organic substances, treated raw water 15b is introduced into depressurization device 28, where the pressure of treated raw water 15b is reduced to separate gas components, such as CO₂ or CH₄ produced by the decomposition of organic substances (step S6). Thereafter, treated raw water 15b is introduced into reverse osmosis membrane device 13 (see FIG. 1) to separate the decomposed remnants remaining in treated raw water 15b (step S7). After the decomposed remnants are separated from treated raw water 15b, treated raw water 15b is introduced into a drinking water treatment device 14 located further downstream (FIG. 1), where a treatment, for example, a drinking water treatment using plasma is performed to prepare tap water as drinking water (step S8), and a series of processes of water treatment are completed.

According to the water treatment of FIG. 3, since raw water 15a containing organic substances is pressurized and heated, so that supercritical water or subcritical water is produced and organic substances contained in raw water 15a are decomposed using the supercritical water or subcritical water, the load to be imposed on reverse osmosis membrane device 13 located further downstream is alleviated. As a result, the purification efficiency of tap water may increase and raw water 15a such as, for example, wastewater or sewage may be almost completely recycled as tap water 16.

Further, the oxidizing power of the supercritical water or subcritical water is so strong to powerfully decompose the organic substances contained in raw water 15a. However, the supercritical water or subcritical water causes the corrosion of the facility, such as a container, a pipe, or a sealing part, that contacts with the supercritical water or subcritical water. However, according to the present exemplary embodiment, since laser light 27 irradiated from laser light source 25 is condensed by condensing lens 26, laser light 27 is locally irradiated to region 29 within small-bore channel 23 spaced apart from the channel wall thereof to produce supercritical water or subcritical water in region 29 within small-bore channel 23 spaced apart from the channel wall to decompose organic substances, and immediately thereafter, the supercritical water or subcritical water is introduced into depressurization device 28 to be depressurized therein, the produced supercritical water or subcritical water does not contact with a facility member including the wall surface of channel 23. Therefore, the corrosion of the facility including the piping may be suppressed in advance.

Further, according to the present exemplary embodiment, since raw water 15a may be continuously introduced from large-bore channel 22 into small-bore channel 23 to be pressurized and continuously irradiated to decompose the organic substances in raw water 15a scaling-up to a large capacity treatment device is easy.

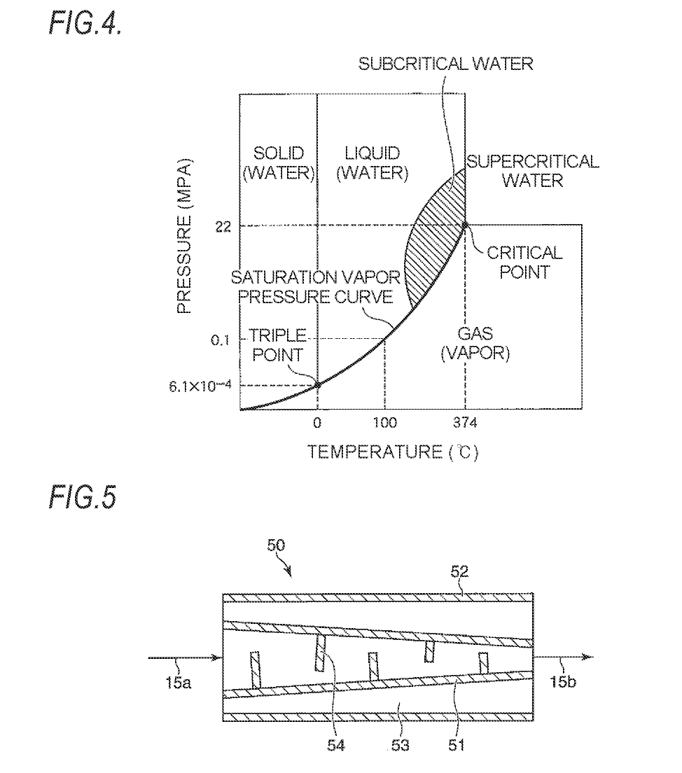

FIG. 4 is a view illustrating a generation condition of supercritical water and subcritical water. The supercritical water refers to water having a pressure of 22 MPa or more and temperature of 374° C. or more. The subcritical water refers to water having a pressure and temperature less than the pressure and temperature of water in the supercritical state, respectively.

In the present exemplary embodiment, raw water 15a containing organic substances is heated to either a temperature of 374° C. or more while applying a pressure of 22 MPa or more, or a temperature of 200° C. or more while applying a pressure suitable for maintaining the liquid state. By doing this, the supercritical water or subcritical water may be produced from the water components contained in raw water 15a and the organic substances contained in raw water 15a may be decomposed and removed using raw water 15a turned into the supercritical water or subcritical water. In the meantime, as described above, the raw water may be turned into the subcritical water under a pressure of supercritical state or less. However, the raw water is required to be in the liquid state at the temperature of 200° C. or more in order for raw water 15a to be effectively turned into the subcritical water state. For this reason, a pressure of 1.5 MPa or more is required in order for the raw water to be turned into subcritical water. Further, in principle, there is no upper limit on the pressure and the temperature required to ensure that the raw water is in the supercritical state. However, a pressure of 100 MPa or less and a temperature of 500° C. or less are required in order to obtain a technical effect of the present invention from a practical point of view.

In the present exemplary embodiment, when the concentration of the decomposed remnants is high in treated raw water 15b after the raw water discharged from outlet of water treatment device 12 is treated with reverse osmosis membrane device 13, treated raw water 15b may be returned to the inlet of water treatment device 12 again to be circulated and treated.

Further, in the present exemplary embodiment, the pressure of the raw water 15b after being treated to decompose the organic substances is recovered by depressurization device 28. For example, a turbo charger is adopted for the pressure recovery device. In the present exemplary embodiment, the turbo charger includes one side impeller disposed within depressurization device 28 and the other side impeller coaxially connected to a rotation axis of the one side impeller and disposed within pressure pump 24. For example, a flow of fluid is formed using a pressure difference when the fluid is depressurized from a high-pressure to a low-pressure in depressurization device 28, the one side impeller is rotated by the flow of fluid, and hence, the other side impeller is rotated. As a result, raw water 15a flows from channel 22 into channel 23.

In the present exemplary embodiment, the pressure is recovered by depressurization device 28 and gas components are discharged from the depressurized treated raw water 15b. The gas components includes gases as decomposed products produced when decomposing solids, in addition to the atmospheric components dissolved in raw water 15a at the time of pressurizing. After being treated to discharge the gas components, treated raw water 15b is turned into a water containing an infinitesimal amount of an amino acid formed as the organic substances are decomposed, and has a usefulness suitable as, for example, fertilizer.

In the present exemplary embodiment, it is preferable that the length of small-bore channel 23 is, for example, about 1 m, and a heat reflection plate is disposed on the channel wall surface inside the channel in the channel wall opposed to the channel wall onto which laser light 27 is irradiated in small-bore channel 23. With this arrangement, heat radiation from small-bore channel 23 may be suppressed.

In the present exemplary embodiment, treated raw water 15b, which is the liquid discharged from the outlet of water treatment device 12, flows into reverse osmosis membrane device 13 located downstream so that the decomposed remnants are separated. However, since most of the organic substances are decomposed by the supercritical water or subcritical water, the load to be imposed on reverse osmosis membrane device is alleviated and a trouble such as, for example, blockage does not occur.

Next, descriptions will be made as to a modified example of the water treatment device according to the first exemplary embodiment of the present invention.

FIG. 5 is a cross-sectional view of the raw water channel which is a main part of a modified example of the water treatment device according to the first exemplary embodiment of the present invention. The raw water channel is a pressure device that corresponds to large-bore raw water channel 22 of FIG. 2A and small-bore raw water channel 22 connected to large-bore raw water channel 22.

In FIG. 5, a raw water channel 50 has a double pipe structure mainly constituted with a tapered inner pipe 51 in which the size of the inner diameter thereof is gradually reduced, and an outer pipe 52 provided concentrically to cover inner pipe 51.

The tapered inner wall surface of inner pipe 51 is provided with a plurality of baffle plates 54, for example, at regular intervals. Accordingly, rapid flow of raw water 15a is impeded by baffle plates 54 and raw water 15a flows to meander in inner pipe 51. As a result, the residual period of raw water 15a in inner pipe 51 becomes longer and the decomposition of the organic substances is enhanced.

In the water treatment device provided with raw water channel 50 configured as described above, raw water 15a is introduced from the large-bore side of inner pipe 51 and pressed out to the small-bore side by the pressure pump not illustrated, thereby being pressurized. By performing the remaining processing steps similarly as in the first exemplary embodiment, laser light is irradiated to the region (see FIG. 2) within channel 51 spaced apart from the channel wall in the small-bore side of inner pipe 51 in which the pressurized raw water 15a flows, to produce supercritical water or subcritical water only in the irradiated region, and by performing the remaining processing steps similarly as in the first exemplary embodiment, the organic substances contained in raw water 15a are decomposed.

According to the modified example of the first exemplary embodiment, since laser light is irradiated only to the region spaced apart from the channel wall within channel in the small-bore side of inner wall 51 in which raw water 15a flows to produce supercritical water or subcritical water, and the organic substances contained in raw water 15a are decomposed by the supercritical water or subcritical water, the load to be imposed on the filtration device located downstream may be alleviated and the corrosion of the facility including piping or the like may be suppressed as in the first exemplary embodiment.

In the modified example of the first exemplary embodiment, a space 53 between inner pipe 51 and outer pipe 52 constituting the double pipe structure is preferably formed with a vacuum insulation layer depressurized to about 1.33×10⁻² Pa (1×10⁻⁴ Torr) to 1.33×10² Pa (1 Torr). By doing this, it is possible to reduce energy loss caused by heat radiation from inner pipe 51. Further, space 53 between inner pipe 51 and outer pipe 52 may be filled with a filler of high porosity, instead of being formed with the vacuum insulation layer. By doing this, heat radiation from tapered inner pipe 51 is suppressed, thereby enhancing an insulating effect.

In the modified example of the second exemplary embodiment, at least the laser light-irradiated portion in each of inner pipe 51 and outer pipe 52 may be formed of a transparent and strong material, for example, a quartz glass. By doing this, it is possible to avoid the attenuation of the laser light irradiated toward raw water 15a from the laser light source.

In the modified example of the present exemplary embodiment, a heat recovering gas may be caused to flow in space 53 between inner pipe 51 and outer pipe 52 to recover the heat radiated from inner pipe 51. In this case, for example, N₂, a CFC substitute and CO₂ may be used as the heat recovering gas and the pressure thereof is maintained at about 0.1 MPa to 5 MPa.

In the modified example of the first exemplary embodiment, heat loss may be reduced by disposing a heat reflection plate made of, for example, a metal on the inner wall surface of inner pipe 52.

Next, descriptions will be made as to a second modified example of the water treatment device according to the first exemplary embodiment of the present invention.

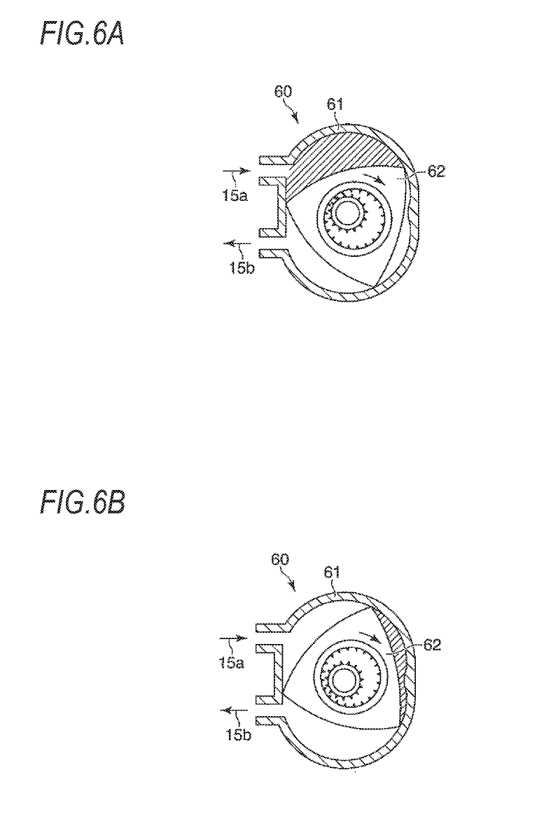

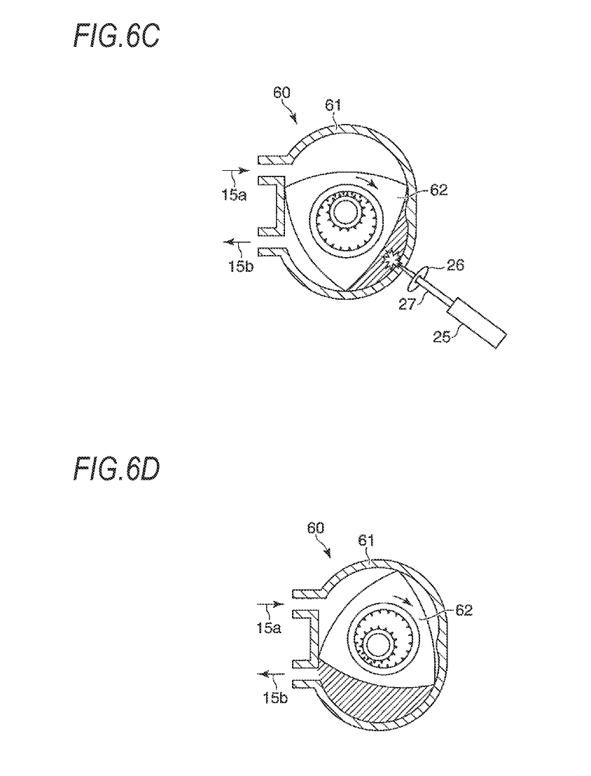

FIG. 6A is a cross-sectional view of the raw water channel at the time when the raw water is introduced into the raw water channel which is a main part of the second modified example of the water treatment device according to the first exemplary embodiment of the present invention. FIG. 6B is a cross-sectional view of the raw water channel at the time when the raw water is pressurized in the raw water channel which is the main part of the second modified example of the water treatment device according to the first exemplary embodiment of the present invention. FIG. 6C is a cross-sectional view of the raw water channel at the time when the raw water is heated (laser light is irradiated) in the raw water channel which is the main part of the second modified example of the water treatment device according to the first exemplary embodiment of the present invention. FIG. 6D is a cross-sectional view of the raw water channel at the time when the raw water is discharged in the raw water channel which is the main part of the another modified example of the water treatment device according to the first exemplary embodiment of the present invention. The raw water channel is a pressure device that pressurizes raw water 15a to a predetermined pressure as similarly in large-bore raw water channel 22 of FIG. 2A and small-bore raw water channel 23 connected to large-bore raw water channel 22.

In FIGS. 6A to 6D, the principle of a rotary engine of a car is applied to a raw water channel 60, which is mainly configured by a oval case 61 narrowed in the middle portion thereof and a substantially triangular rotor 62 rotating in the oval case 61.

In the water treatment device having raw water channel 60 configured as described above, raw water 15a is introduced into case 61 by rotating rotor 62 (FIG. 6A), raw water 15a is compressed to be pressurized between rotor 62 and case 61 (FIG. 6B), then laser light 27 is irradiated to pressurized raw water 15a only in a region spaced apart case 61 to heat raw water 15a to produce supercritical water or subcritical water under a high-pressure and high-temperature state, and the organic substances contained in raw water 15a are decomposed by the supercritical water or subcritical water (FIG. 6C). After being treated to decompose the organic substances, raw water 15b is discharged from case 61 (FIG. 6D). A series of processes in FIGS. 6A to 6D are performed while rotor 62 is making one revolution.

According to the another modified example of the present another embodiment, since the principle of a rotary engine is employed to pressurize raw water 15a, it is possible to efficiently pressurize raw water 15a and finally decompose and treat organic substances contained in raw water 15a continuously and efficiently, in addition to the effects of the another exemplary embodiments described above.

Further, according to the another modified example of the another embodiment, since rotor 62 is formed in a substantially triangular shape, raw water 15a may be pressurized three times per each revolution of rotor 62 and the supercritical water or subcritical water may be produced three times by irradiating the laser light three times. As a result, the organic substances contained in raw water 15a may be highly efficiently decomposed and treated.

In the another modified example of the another embodiment, at least the laser light-irradiated portion in case 61 is preferably made of a transparent material, for example, a quartz glass. Laser light 27 emitted from laser light source 25 and condensed by condensing lens 26 may be condensed to a region within the case spaced apart from the wall surface of case 61 without attenuating the laser light 27, thereby producing supercritical water or subcritical water within the region.

In addition, in the another modified example of the present embodiment, the treatment rate of raw water 15a may be further increased by increasing the number of revolutions of roller 62.

As described above, the present invention is described using embodiments thereof, but is not limited to the respective embodiments described above.

### EXPLANATION OF SYMBOLS

12: water treatment device
15, 15a: raw water containing organic substances
15b: treated raw water
22: large-bore channel
23: small-bore channel
24: pressure pump
25: laser light source
26: condensing lens
27: laser light
28: depressurization device
29: region spaced apart from channel wall within channel

What is claimed is:

1. A water treatment device characterized by comprising:
a pressure device that pressurizes raw water containing organic substances to a predetermined pressure; and
a heating device that heats the raw water pressurized by the pressure device to a predetermined temperature to produce supercritical water or subcritical water and decomposes the organic substances contained in the raw water using the supercritical water or subcritical water, wherein the heating device comprises:
a laser light irradiation device that irradiates laser light towards the raw water pressurized by the pressure device; and
a condensing lens that condenses the laser light irradiated from the laser light irradiation device on a region spaced apart from a channel wall within the channel where the pressurized raw water flows.

2. The water treatment device of claim 1, wherein the pressure device introduces the raw water from a large-bore channel into a small-bore channel of which the cross-sectional area is smaller than that of the large-bore channel to pressurize the raw water.

3. The water treatment device of claim 2, wherein at least a part of the channel wall of the small-bore channel is transparent, and the laser light irradiation device irradiates the laser light on a region within the small-bore channel through the transparent channel wall.

4. The water treatment device of claim 2, wherein the small-bore channel has a double pipe structure, and a vacuum insulation layer is formed in a space between the inner pipe and the outer pipe of the double pipe structure.

5. The water treatment device of claim 2, wherein the small-bore channel has a double pipe structure, and a heat recovering gas flows through the space between the inner pipe and the outer pipe of the double pipe structure.

6. The water treatment device of claim 2, wherein the small-bore channel has a double pipe structure, and the space between the inner pipe and the outer pipe of the double pipe structure is filled with a filler having voids.

7. The water treatment device of claim 2, wherein a thermal reflection plate is disposed on the channel wall surface inside the channel in the channel wall opposed to the channel wall of the small-diameter channel on which the laser light is irradiated.

8. The water treatment device of claim 1, wherein the predetermined pressure is 1.5 MPa to 100 MPa, and the predetermined temperature is 200° C. to 500° C.

9. The water treatment device of claim 8, wherein the predetermined pressure is 1.5 MPa to 100 MPa, the predetermined temperature is 200° C. to 374° C., and the raw water is in the liquid state.

10. The water treatment device of claim 8, wherein the predetermined pressure is 22 MPa to 100 MPa, and the predetermined temperature is 374° C. to 500° C.

11. A water treatment method comprising:
pressurizing raw water containing organic substances to a predetermined pressure; and
heating the raw water pressurized by the pressurizing to a predetermined temperature to produce supercritical water or subcritical water and decomposes the organic substances contained in the raw water using the supercritical water or subcritical water,
wherein the heating comprises:
irradiating laser light towards the raw water pressurized by the pressurizing; and
condensing the laser light irradiated in the irradiating on a region spaced apart from a channel wall of within the channel where the pressurized raw water flows.

12. The water treatment method of claim 11, wherein in the pressurizing, the raw water is introduced from a large-bore channel into a small-bore channel of which the cross-sectional area is smaller than that of the large-bore channel to pressurize the raw water.

13. The water treatment method of claim 12, wherein at least a part of the channel wall of the small-bore channel is transparent, and in the irradiating, the laser light is irradiated to a region within the small-bore channel through the transparent channel wall.

14. The water treatment method of claim 12, wherein the small-bore channel has a double pipe structure, and the water treatment method further includes causing a gas to flow through the space between the inner pipe and the outer pipe of the double pipe structure to recover the heat discharged from the inner pipe.

15. The water treatment method of claim 11, wherein the predetermined pressure is 1.5 MPa to 100 MPa, and the predetermined temperature is 200° C. to 500° C.

16. The water treatment method of claim 15, wherein the predetermined pressure is 22 MPa to 100 MPa, the predetermined temperature is 200° C. to 374° C., and the raw water is in a liquid state.

17. The water treatment method of claim 15, wherein the predetermined pressure is 22 MPa to 100 MPa, and the predetermined temperature is 374° C. to 500° C.
